(19) United States
(12) Patent Application Publication
(10) Pub. No.: US 2020/0240070 A1
(43) Pub. Date: Jul. 30, 2020

(54) Household Intelligent Clothes Dryer with Thermal Uniformity and Dust Filtering Function

(71) Applicant: Ngoi Kwan Lau, Hong Kong (HK)

(72) Inventor: Ngoi Kwan Lau, Hong Kong (HK)

(21) Appl. No.: 16/373,596

(22) Filed: Apr. 2, 2019

(30) Foreign Application Priority Data
Jan. 29, 2019 (CN) 210910083324.9

(51) Int. Cl. D06F 58/10; D06F 58/22; B01D 46/10; D06F 58/28; D06F 58/26; B01D 46/00

(52) U.S. Cl. CPC D06F 58/10; D06F 58/22; B01D 46/10; B01D 2279/35; D06F 58/26; B01D 46/0005; B01D 2277/30; D06F 58/28

(57) ABSTRACT

The invention relates to a household intelligent clothes dryer with thermal uniformity and dust filtering function which includes a box body. The box body is provided with a positioning slot, the left end of the box body is hinged with a cabinet door, and the box body is provided with a drying device. The box body is fixedly connected with the rotating device, and the upper end of the positioning slot is fixedly connected with a hanger device. The cabinet door is provided with an observation window, and the lower end of the box body is provided with an air exhaust hole. The drying device includes a bellows, a card slot, a bayonet, a spring, a support strip, a high-efficiency filter net, a support piece and a fan. The bellows is fixedly sleeved with the box body, and the bellows is provided with the card slot. The card slot is connected to the bayonet. The outer side of the bayonet is sleeved with the spring. The bayonet is slidably sleeved with the support strip. The household intelligent clothes dryer with thermal uniformity and dust filtering function can use the drying device to filter the dust in the air to prevent the dust from staining the clothes. The rotating device can make the clothes to be evenly dried, avoiding the local drying of the clothes, and improving the drying effect.

### FIELD OF THE INVENTION

The invention relates to a novel intelligent household dryer, in particular to a household intelligent clothes dryer with thermal uniformity and dust filtering function.

### BACKGROUND

With the continuous advancement of technology, more and more new technologies are used in household products to provide convenience for people's lives. Intelligent equipment has also emerged as the times require, and it has begun to spread in household products. In the cold winter, when the family changes more clothes, if the weather is not good, the clothes are difficult to dry. Some clothes are still wet after the washing machine is over, and some households use the dryer to dry the clothes. But when drying, due to the large amount of particles in the air, the dust in the air will enter the clothes, affecting the cleanliness of the clothes. In addition, the drying of the clothes of the ordinary dryer is uneven, resulting in partial drying, and the drying effect is poor.

### SUMMARY OF THE INVENTION

The technical problem to be solved is to overcome the above-mentioned deficiency by providing a household intelligent clothes dryer with thermal uniformity and dust filtering function.

To solve the problem, the present invention provides the following technical solution. A household intelligent clothes dryer with thermal uniformity and dust filtering function includes a box body. The box body is provided with a positioning slot, the left end of the box body is hinged with a cabinet door, and the box body is provided with a drying device. The box body is fixedly connected with the rotating device, and the upper end of the positioning slot is fixedly connected with a hanger device. The cabinet door is provided with an observation window, and the lower end of the box body is provided with an air exhaust hole.

The drying device includes a bellows, a card slot, a bayonet, a spring, a support strip, a high-efficiency filter net, a support piece and a fan. The bellows is fixedly sleeved with the box body, and the bellows is provided with the card slot. The card slot is connected to the bayonet. The outer side of the bayonet is sleeved with the spring. The bayonet is slidably sleeved with the support strip. The outer side of the support strip is sleeved with the high-efficiency filter net. The right end of the high-efficiency filter net is attached to the support piece. The support piece is fixedly connected to the support strip. The bellows is fixedly connected to the fan, and the plug of the fan is plugged into an external power source.

The rotating device includes a motor, a metal tube, a ventilation slot, a rotating tube, an air outlet, a loop and a ventilation tube. An end of the rotating shaft of the motor is fixedly connected with a metal tube, and the metal tube is provided with a ventilation slot. The rotating tube is fixedly connected to a lower end of the medal tube. The lower end of the rotating tube is provided with the air outlet. The outer side of the metal tube is slidably sleeved with the loop.

The hanger device includes a base, a screw, a support cylinder, a support rod, a sliding ring, a sliding seat, a horizontal rod, a groove, a limiting slot, a positioning shaft, a connecting rod and a limiting rod. The base is slidably connected with the positioning slot. The base is fastened to the box body by the screw. The upper end of the base is fixedly connected with a support cylinder. The support cylinder is sleeved with the support rod, and the outer side of the support rod is sleeved with a sliding ring. The outer side of the support rod is sleeved with the sliding seat. The sliding seat is fixedly connected with the sliding ring. The supporting rod is provided with the limiting slot. The right end of the sliding ring is fixedly connected with a positioning shaft, and the outer side of the positioning shaft is movably sleeved with the connecting rod. The left end of the connecting rod is fixedly connected with the limiting rod, and the limiting rod is engaged with the limiting slot.

Preferably, the left end of the loop is fixedly connected with a ventilation tube, and the ventilation tube is fixedly connected with the bellows.

Preferably, the sliding seat is fixedly connected to the horizontal rod, and the horizontal rod is provided with the groove.

Preferably, the observation window is fixedly engaged with the cabinet door, and the observation window is transparent, and the observation window is made of synthetic resin.

Preferably, the support piece is slidably connected to the bellows, and the support piece is made of stainless steel and has a porous hollow structure.

Preferably, the motor is fixedly connected to the box body, and the plug of the motor is plugged into an external power source.

Compared with the prior art, the technical effects of the present invention are: a household intelligent clothes dryer with thermal uniformity and dust filtering function can use the drying device to filter the dust in the air to prevent the dust from staining the clothes. The rotating device can make the clothes to be evenly dried, avoiding the local drying of the clothes, and improving the drying effect.

### BRIEF DESCRIPTION OF THE DRAWINGS

The invention is illustrated by the following figures and embodiments.

FIG. 1 shows a schematic diagram of whole structure of a household intelligent clothes dryer with thermal uniformity and dust filtering function in accordance with an example embodiment.

FIG. 2 shows a cross section of a bellows of a household intelligent clothes dryer with thermal uniformity and dust filtering function in accordance with an example embodiment.

FIG. 3 shows a side view of a support piece of a household intelligent clothes dryer with thermal uniformity and dust filtering function in accordance with an example embodiment.

FIG. 4 shows a schematic diagram of a rotating tube of a household intelligent clothes dryer with thermal uniformity and dust filtering function in accordance with an example embodiment.

FIG. 5 shows a schematic diagram of a metal tube of a household intelligent clothes dryer with thermal uniformity and dust filtering function in accordance with an example embodiment.

FIG. 6 shows an enlarged view of part a of a household intelligent clothes dryer with thermal uniformity and dust filtering function in accordance with an example embodiment.

FIG. 7 shows a schematic diagram of a support rod of a household intelligent clothes dryer with thermal uniformity and dust filtering function in accordance with an example embodiment.

The reference numbers of the figures are as follows:

1: box body; 11: positioning slot; 2: cabinet door; 3: drying device; 31: bellows; 32: card slot; 33: bayonet; 34: spring; 35: support strip; 36: high-efficient filter net; 37: support piece; 38: fan; 4: rotating device; 41: motor; 42: metal tube; 43: ventilation slot; 44: rotating tube; 45: air outlet; 46: loop; 47: ventilation tube; 5: hanger device; 51: base; 52: screw; 53: support cylinder; 54: support rod; 55: sliding ring; 56: sliding seat; 57: horizontal rod; 58: groove; 59: limiting slot; 510: positioning shaft; 511: connecting rod; 512: limiting rod; 6: observation window; 7: air exhaust hole.

### DETAILED DESCRIPTION

The invention is illustrated in accordance with figures. The figures as simplified diagrams demonstrate the basic structures of the apparatus of embodiments of the invention. Thus, the invention is not limited to the figures.

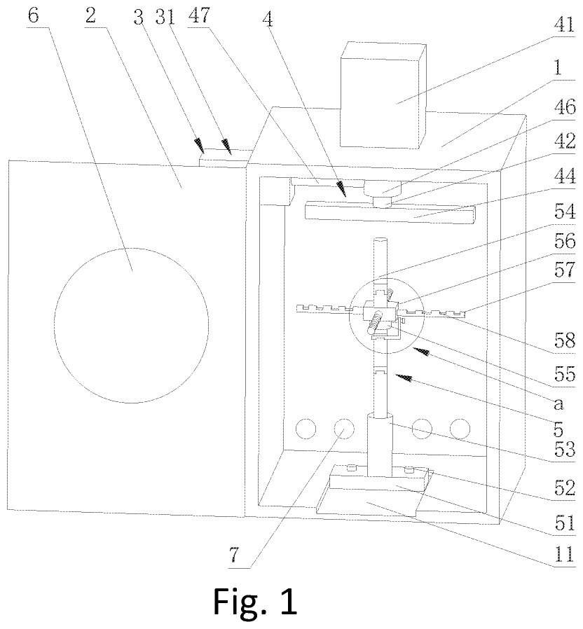

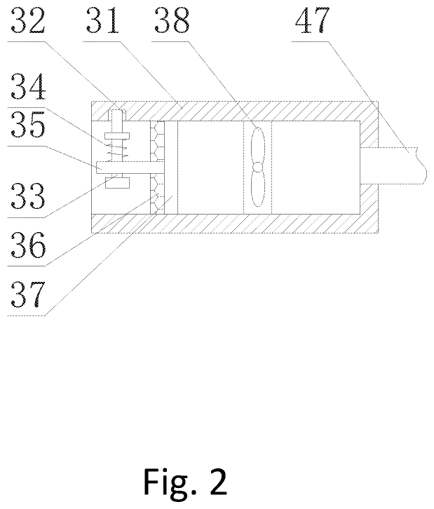

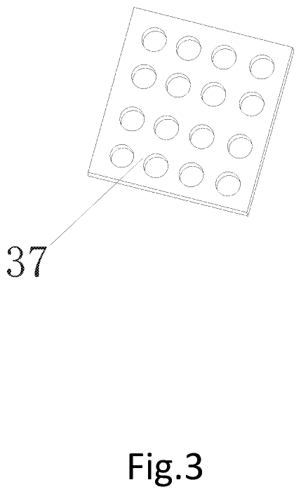

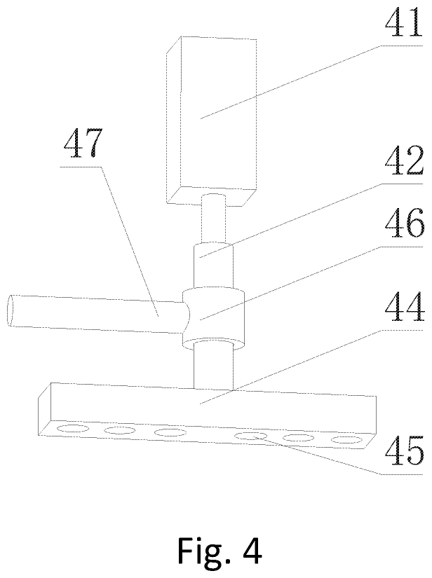

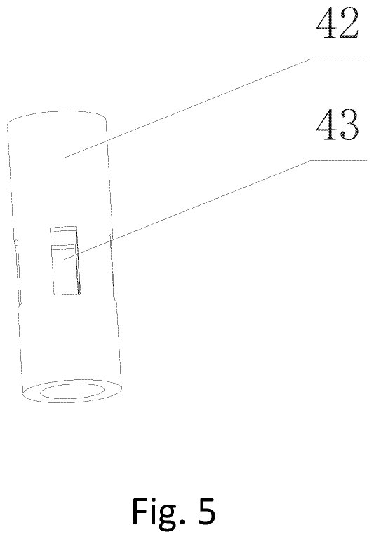

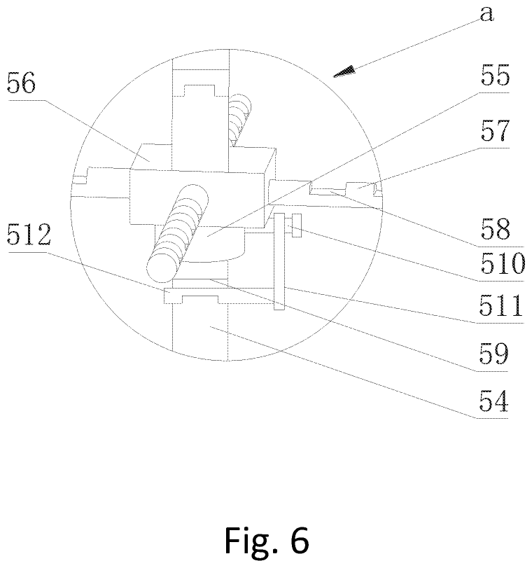

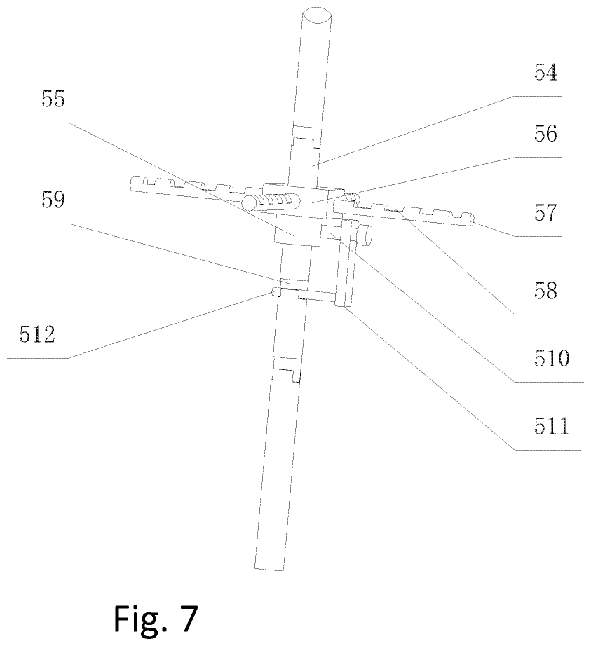

Referring to FIGS. 1-7, the technical solution of the present invention provides a household intelligent clothes dryer with thermal uniformity and dust filtering function which includes a box body 1. The inner cavity of the box body 1 is provided with a positioning slot 11, the left end of the box body 1 is hinged with a cabinet door 2, and the box body 1 is provided with a drying device 3. The box body 1 is fixedly connected with the rotating device 4, and the upper end of the positioning slot 11 is fixedly connected with a hanger device 5. The cabinet door 2 is provided with an observation window 6 which facilitates people to observe clothes. The observation window 6 is fixedly engaged with the cabinet door 2, and the observation window 6 is transparent, and the observation window 6 is made of synthetic resin which facilitates people to understand the status of drying of the clothes and avoid the clothes being burnt. The box body 1 is provided with a temperature and humidity sensor which is connected to a single chip microcomputer. When the temperature and humidity exceed the preset value, the alarm is on and the drying is stopped. The lower end of the box body 1 is provided with an air exhaust hole 7 for removing the generated hot and humid gas. The air exhaust hole 7 is connected to the outdoor through the pipeline to prevent the hot and humid gas from affecting the indoor environment, and the air exhaust hole 7 is further provided with a filter net to prevent dust in the air from entering the box body to contaminate the clothes.

The drying device 3 includes a bellows 31, a card slot 32, a bayonet 33, a spring 34, a support strip 35, a high-efficiency filter net 36, a support piece 37 and a fan 38. The bellows 31 is fixedly sleeved with the box body 1, and the bellows 31 is provided with the card slot 32. The card slot 32 is connected to the bayonet 33. The card slot 32 limits the bayonet 33 to avoid its radial movement. The outer side of the bayonet 33 is sleeved with the spring 34, and has a compressive elastic force, so that the bayonet 33 and the card slot 32 can be closely attached. The bayonet 33 is slidably sleeved with the support strip 35. The outer side of the support strip 35 is sleeved with the high-efficiency filter net 36. The high-efficiency filter net 36 can filter the dust. The right end of the high-efficiency filter net 36 is attached to the support piece 37 to support the high-efficiency filter net 36. The support piece 37 is fixedly connected to the support strip 35. The support piece 37 is slidably connected to the bellows 31, and the support piece 37 is made of stainless steel and has a porous hollow structure to make air pass. The bellows 31 is fixedly connected to the fan 38, and the model number is KR-001, which can blow hot air. The plug of the fan 38 is plugged into an external power source.

The rotating device 4 includes a motor 41, a metal tube 42, a ventilation slot 43, a rotating tube 44, an air outlet 45, a loop 46 and a ventilation tube 47. The motor 41 is fixedly connected to the box body 1. The plug of the motor 41 is plugged into an external power source, and the motor 41 is fixedly connected to the box body 1, the model number is YE2. The plug of the motor 41 is plugged into an external power source, and the end of the rotating shaft of the motor 41 is fixedly connected to the metal tube 42. The metal tube 42 is provided with a ventilation slot 43 communicating with the inner cavity thereof. The lower end of the metal tube 42 is fixedly connected with a rotating tube 44. The lower end of the rotating tube 44 is provided with an air outlet 45, and the outer side of the metal tube 42 is slidably sleeved with the loop 46. The loop 46 is movably sleeved with the metal tube 42, and tightly fitted to avoid air leakage. The left end of the loop 46 is fixedly connected with a ventilation tube 47, and the ventilation tube 47 is fixedly connected with the air outlet of the bellows 31.

The hanger device 5 includes a base 51, a screw 52, a support cylinder 53, a support rod 54, a sliding ring 55, a sliding seat 56, a horizontal rod 57, a groove 58, a limiting slot 59, a positioning shaft 510, a connecting rod 511 and a limiting rod 512. The base 51 is slidably connected with the positioning slot 11. The base 51 is fastened to the box body 1 by the screw 52. The upper end of the base 51 is fixedly connected with a support cylinder 53. The support cylinder 53 is sleeved with the support rod 54, and the outer side of the support rod 54 is sleeved with a sliding ring 55. The outer side of the support rod 54 is sleeved with the sliding seat 56. The sliding seat 56 is fixedly connected with the sliding ring 55. The supporting rod 54 is provided with the limiting slot 59. The right end of the sliding ring 55 is fixedly connected with a positioning shaft 510, and the outer side of the positioning shaft 510 is movably sleeved with the connecting rod 511. The left end of the connecting rod 511 is fixedly connected with the limiting rod 512, and the limiting rod 512 is engaged with the limiting slot 59 to limit the limiting rod 512, so that the sliding ring 55 is limited, the sliding seat 56 is limited, the horizontal rod 57 is limited. The sliding seat 56 is fixedly connected to the horizontal rod 57. The horizontal rod 57 is provided with a groove 58 for hanging the clothes hanger.

When the invention is carried out: when the clothes need to be dried, the plug of the fan 38 is inserted, the fan 38 works. The air outside the bellows 31 passes through the bellows 31, the high-efficiency filter net 36, the support piece 37, the fan 38, and the ventilation tube 47, the loop 46, the metal tube 42, the rotating tube 44 and the air exhaust hole 45. When it passes through the fan 38, the hot air is generate, so that the blown hot air dries the clothes. When the air passes through the high-efficiency filter net 36, the dust in the air is effectively filtered to prevent the dust from staining the clothes, and the clothes is kept clean. When the dust on the left side of the high-efficiency filter 36 needs to be removed, the bayonet 33 is moved downward, the spring 34 is compressed, and the bayonet 33 is separated from the slot 32. Then, the support strip 35 is moved to the left, the support piece 37 slides to the left along the inner wall of the bellows 31. The high-efficiency filter net 36 slides to the left, and the dust accumulated on the left side of the high-efficiency filter net 36 is swept out of the bellows 31 to remove the dust. It is convenient and quick to replace the high-efficiency filter net 36. When the drying device 3 is in operation, the plug of the motor 41 is inserted, the motor 41 is operated, the metal tube 42 is rotated, and the rotating tube 44 is rotated, so that the hot air of the rotating tube 44 uniformly dries the clothes to avoid partially drying the laundry, resulting in poor drying. When it is necessary to adjust the height of the hanger device 5, the support rod 54 is grasped, the sliding ring 55 is lifted up. Then the limiting rod 512 is outwardly moved, so that the limiting rod 512 leaves the limiting slot 59, and the sliding ring 55 is continuously lifted up. The sliding seat 56 is moved upward, the horizontal rod 57 is moved upward, and then the limiting rod 512 is locked into the next limiting slot 59. It will limit the limiting rod 512 is limited, so that the sliding ring 55 is limited, the sliding seat 56 is limited, the horizontal rod 57 is limited, thereby the height is adjusted. It is convenient and quick, and is convenient for people to carry out the hanging of the clothes.

The exemplary embodiments of the present invention are thus fully described. Although the description referred to particular embodiments, it will be clear to one skilled in the art that the present invention may be practiced with variations of these specific details. Hence this invention should not be construed as limited to the embodiments set forth herein.

What is claimed is:

1. A household intelligent clothes dryer with thermal uniformity and dust filtering function, comprising: a box body 1, wherein the box body 1 is provided with a positioning slot 11, the left end of the box body 1 is hinged with a cabinet door 2, and the box body 1 is provided with a drying device 3; the box body 1 is fixedly connected with the rotating device 4, and the upper end of the positioning slot 11 is fixedly connected with a hanger device 5; the cabinet door 2 is provided with an observation window 6, and the lower end of the box body 1 is provided with an air exhaust hole 7,
wherein the drying device 3 includes a bellows 31, a card slot 32, a bayonet 33, a spring 34, a support strip 35, a high-efficiency filter net 36, a support piece 37 and a fan 38; the bellows 31 is fixedly sleeved with the box body 1, and the bellows 31 is provided with the card slot 32; the card slot 32 is connected to the bayonet 33; the outer side of the bayonet 33 is sleeved with the spring 34; the bayonet 33 is slidably sleeved with the support strip 35; the outer side of the support strip 35 is sleeved with the high-efficiency filter net 36; the right end of the high-efficiency filter net 36 is attached to the support piece 37; the support piece 37 is fixedly connected to the support strip 35; the bellows 31 is fixedly connected to the fan 38; and the plug of the fan 38 is plugged into an external power source,
wherein the rotating device 4 includes a motor 41, a metal tube 42, a ventilation slot 43, a rotating tube 44, an air outlet 45, a loop 46 and a ventilation tube 47; an end of the rotating shaft of the motor 41 is fixedly connected with a metal tube 42, and the metal tube 42 is provided with a ventilation slot 43; the rotating tube 44 is fixedly connected to a lower end of the medal tube 42; the lower end of the rotating tube 44 is provided with the air outlet 45; the outer side of the metal tube 42 is slidably sleeved with the loop 46,
wherein the hanger device 5 includes a base 51, a screw 52, a support cylinder 53, a support rod 54, a sliding ring 55, a sliding seat 56, a horizontal rod 57, a groove 58, a limiting slot 59, a positioning shaft 510, a connecting rod 511 and a limiting rod 512; the base 51 is slidably connected with the positioning slot 11; the base 51 is fastened to the box body 1 by the screw 52; the upper end of the base 51 is fixedly connected with a support cylinder 53; the support cylinder 53 is sleeved with the support rod 54, and the outer side of the support rod 54 is sleeved with a sliding ring 55; the outer side of the support rod 54 is sleeved with the sliding seat 56; the sliding seat 56 is fixedly connected with the sliding ring 55; the supporting rod 54 is provided with the limiting slot 59; the right end of the sliding ring 55 is fixedly connected with a positioning shaft 510, and the outer side of the positioning shaft 510 is movably sleeved with the connecting rod 511; the left end of the connecting rod 511 is fixedly connected with the limiting rod 512, and the limiting rod 512 is engaged with the limiting slot 59.

2. The household intelligent clothes dryer with thermal uniformity and dust filtering function of claim 1, wherein the left end of the loop 46 is fixedly connected with a ventilation tube 47, and the ventilation tube 47 is fixedly connected with the bellows 31.

3. The household intelligent clothes dryer with thermal uniformity and dust filtering function of claim 1, wherein the sliding seat 56 is fixedly connected to the horizontal rod 57, and the horizontal rod 57 is provided with the groove 58.

4. The household intelligent clothes dryer with thermal uniformity and dust filtering function of claim 1, wherein the observation window 6 is fixedly engaged with the cabinet door 2, and the observation window 6 is transparent, and the observation window 6 is made of synthetic resin.

5. The household intelligent clothes dryer with thermal uniformity and dust filtering function of claim 1, wherein the support piece 37 is slidably connected to the bellows 31, and the support piece 37 is made of stainless steel and has a porous hollow structure.

6. The household intelligent clothes dryer with thermal uniformity and dust filtering function of claim 1, wherein the motor 41 is fixedly connected to the box body 1, and the plug of the motor 41 is plugged into an external power source.
